(19) United States
(12) Patent Application Publication
(10) Pub. No.: US 2005/0010897 A1
(43) Pub. Date: Jan. 13, 2005

(54) Program generating apparatus

(76) Inventors: Hajime Ogawa, Suita-shi (JP); Taketo Heishi, Osaka-shi (JP); Shuichi Takayama, Takarazuka-shi (JP); Chen Zhao, Beijing (CN)

Correspondence Address: WENDEROTH, LIND & PONACK, L.L.P., 2033 K STREET N. W., SUITE 800, WASHINGTON, DC, 20006-1021, US

(21) Appl. No.: 10/880,523

(22) Filed: Jul. 1, 2004

(30) Foreign Application Priority Data
Jul. 9, 2003 (CN) 03147234.6

(51) Int. Cl. G06F 9/44

(52) U.S. Cl. 717/106; 717/136

(57) ABSTRACT

A test program generating apparatus for a compiler comprising: a conditional expression generating unit operable to receive a description of a control structure of a program and generate a plurality of conditional expressions to be inserted into insert parts of the conditional expressions of the control structure using a linear programming method, the plurality of conditional expressions allowing a control flow of the program to pass through all paths in the control structure; an initial value generating unit operable to generate initial values of variables, for each of all the paths, which are included in the plurality of conditional expressions for allowing the control flow of the program to pass through all the paths in the control structure; and a test program generating unit operable to generate a test program based on the control structure, the conditional expressions and the initial values.

### BACKGROUND OF THE INVENTION

(1) Field of the Invention

This present invention relates to a program generating apparatus, especially a program generating apparatus that generates a test program for testing a compiler.

(2) Description of the Related Art

At the time of generating a compiler, whether the compiler operates right or not must be tested. Therefore, an apparatus that automatically generates a test program for a compiler has been proposed (for example, Japanese Laid-Open Patent application H5-342054).

An example of a test program generating method by a conventional test program generating apparatus will be explained below. In the conventional test program generating apparatus, a test program for a target compiler will be generated from a program (called “MLSL program” from here) described in the later-explained middle level script language (MLSL).

FIG. 1 is a flow chart indicating a test program generating processing of a compiler by a conventional test program generating apparatus. The test program generating apparatus searches the MLSL program 52 as shown in FIG. 2A for a path that can be passed through by the control flow of the MLSL program 52 (S72). The MLSL is a language for describing the control structure of a program described in a high-level language. Therefore, neither variable nor equation is described in the MLSL program 52.

Note that the test program generating apparatus interprets the MLSL program 52 as the MLSL program 54 shown in FIG. 2B. In other words, alphabets A to F shows locations that may be passed through at the time of executing the program, and it is interpreted that an assignment statement such as “a=a+1;”, a function and the like are described in each of the locations A to F. Also, it is interpreted that an inequality is described as the conditional expressions 1 and 2.

FIG. 3 is a diagram showing the list of a path that may be passed through by the control flow of the MLSL program 54. In other words, the control flow of the MLSL program 54 can pass through three paths. For example, in the case where both the conditional expressions 1 and 2 are true, the control flow of the MLSL program 54 passes through these locations in an order of A, B, C, D and F as shown in path number 1.

Next, the test program generating apparatus generates conditional expressions to be inserted into the test program at random (S74). FIG. 2C shows an example of a program including conditional expressions generated at random. Here, an inequality of “x>0” is generated as the conditional expression 1, and another inequality of “x+y+z>2” is generated as the conditional expression 2.

After that, the test program generating apparatus generates initial values of variables included in the generated conditional expressions at random (S76) and a test program (S78). FIG. 2D shows an example of a test program including initial values generated at random. Function init_val1( ) that assigns 2, 3, and 4 to initial values of variables x, y and z respectively is generated. Also, function init_val1( ) is called in the leading part of the test function func1( ) of the compiler and initial values of variables x, y and z are set. Therefore, executing function init_val1( ) sets 2, 3 and 4 as the variables x, y and z respectively, which makes the conditional expression 1 “x>0” and 2 “x+y+z>2” true respectively. Therefore, executing function func1( ) means passage of a path with path number 1 shown in FIG. 3.

Next, the test program generating apparatus judges whether the control flow of the test program that passes through all the passable paths has already been generated or not (S80). In the case where it is judged that the control flow of a test program that passes through all the paths has already been generated (YES in S80), the processing is finished. In the case where it is judged that the control flow of a test program that passes through all the paths has not already been generated (NO in S80), a control for returning to the initial value generating processing (S76) is performed so as to generate the control flow of a test program that passes through the other paths.

Up to this point, the test program generating apparatus can generate a test program whose control flow passes through all the paths.

However, a conventional test program generating apparatus has a problem that it takes a lot of time to finish generating a test program whose control flow passes through all the paths. The reason of this problem will be explained below. FIG. 4 is a diagram showing initial values of variables x, y and z that are generated by the initial value generating processing (S76 in FIG. 1) associating with the path numbers of paths which are passed through by the control flow of the test program. For example, in the case where “x=2, y=3, z=4” are set as initial values, the control flow of the test program passed through the path of path number 1 shown in FIG. 3. As shown in FIG. 4, in the case of generating initial values at random, it takes a lot of time to finish generating the test program whose control flow passes through all the paths because it may doubly generate initial values that make the control flow of the program pass through the same path (for example, the path of path number 1).

Also, according to a conditional expression, there is a problem that the control flow of the test program that passes through all the paths cannot be generated. FIG. 5 is a diagram showing an example of the test program including conditional expressions like this. In the program shown in FIG. 5, it is impossible to generate the initial value of variable x that makes both the conditional expression 1 “x>0” and the conditional expression 2 “x<−2” true. Therefore, it is impossible to make the control flow of the test program pass through the path of path number 1 shown in FIG. 3.

### SUMMARY OF THE INVENTION

The present invention is conceived considering conventional problems like this, and an object of the present invention is to provide a program generating apparatus that can generate a program where a control flow of the program passes through all the paths in a short time.

Another object is to provide a program generating apparatus that can generate a test program whose control flow can surely pass through all the paths.

The program generating apparatus concerning the present invention comprising: a conditional expression generating unit operable to receive a description of a control structure of a program and generate a plurality of conditional expressions to be inserted into insert parts of the conditional expressions of the control structure using a linear programming method, the plurality of conditional expressions allowing a control flow of the program to pass through all paths in the control structure; an initial value generating unit operable to generate initial values of variables, for each of all the paths, which are included in the plurality of conditional expressions for allowing the control flow of the program to pass through all the paths in the control structure; and a program generating unit operable to generate a test program based on the control structure, the plurality of conditional expressions and the initial values.

With this structure, plural conditional expressions that make the control flow of the test program pass through all the passable paths in the control structure are generated using a linear programming method. Therefore, it is possible to generate a program whose control flow passes through all the paths in a short time. Also, the control flow of the program can surely pass through all the paths when executed.

Preferably, the initial value generating unit generates initial values of variables, for each of all the paths, which are included in the plurality of conditional expressions for allowing the control flow of the program to pass through all the paths in the control structure using the linear programming method.

In this way, initial values included in the plural conditional expressions are generated for paths using a linear programming method in the initial value generating unit. This makes it possible to eliminate the possibility of generating the initial values that make the control flow of the program pass through the same paths. Also, the processing of the conditional expression generating unit guarantees the presence of the initial values that make the control flow of the program pass through each path. This makes it possible to generate a program whose control flow passes through all the paths in a short time.

The program generating apparatus concerning another aspect of the present invention comprising: a conditional expression generating unit operable to receive a description of a control structure of a program and generate a plurality of conditional expressions to be inserted into insert parts of the conditional expressions of the control structure, the plurality of conditional expressions allowing a control flow of the program to pass through all paths in the control structure; an initial value generating unit operable to generate initial values of variables, for each of all the paths using a linear programming method, which are included in the plurality of conditional expressions for allowing the control flow of the program to pass through all the paths in the control structure; and a program generating unit operable to generate a test program based on the control structure, the plurality of conditional expressions and the initial values.

With this structure, initial values included in plural conditional expressions are generated for each path using a linear programming method. This makes it possible to generate a program whose control flow passes through all the paths in a short time because no same initial values for making the control flow of the program pass through the same paths are doubly generated.

Note that the present invention can be realized not only as a program generating apparatus like explained above but also as a program generating method comprising steps of the corresponding units of the program generating apparatus and a program for causing a computer to execute the program generating method. It is needless to say that the program like this can be distributed via a recording medium such as a Compact Disc-Read Only Memory (CD-ROM) or a transmission medium such as the Internet.

### FURTHER INFORMATION ABOUT TECHNICAL BACKGROUND TO THIS APPLICATION

The disclosure of Chinese Patent Application No. 03147234.6 filed on Jul. 9th, 2003 including specification, drawings and claims is incorporated herein by reference in its entirety.

The disclosure of Japanese Patent Application No. 2003-388660 filed on Nov. 19th, 2003 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a flow chart showing the test program generating processing for a compiler by a conventional test program generating apparatus.

FIG. 2A to 2D are diagrams for explaining the process where the conventional test program generating apparatus generates a test program from the MLSL program. FIGS. 2A and 2B are diagrams for explaining an example of the MLSL program. FIG. 2C is a diagram showing an example of the program after conditional expressions are generated. FIG. 2D is a diagram showing an example of the test program after initial values are generated.

FIG. 3 is a diagram showing a list of paths that may be passed through by the control flow of the MLSL program shown in FIG. 2B.

FIG. 4 is a diagram showing the relation between the initial values of variables x, y and z generated by the conventional test program generating apparatus and the path numbers of the paths that are passed through by the control flow of the test program when generating these initial values.

FIG. 5 is a diagram for explaining problems of the conventional test program generating apparatus.

FIG. 6 is an external view of the program generating apparatus concerning an embodiment of the present invention.

FIG. 7 is a block diagram showing the functional structure of the program generating apparatus concerning the embodiment of the present invention.

FIG. 8 is a flow chart of the processing executed by the test program generating apparatus.

FIG. 9A to 9D are diagrams for explaining the process of generating the test program from the MLSL program. FIGS. 9A and 9B are diagrams for showing examples of the MLSL program. FIG. 9C is a diagram showing an example of the program after conditional expressions are generated. FIG. 9D is a diagram showing an example of the test program after initial values are generated.

FIG. 10 is a diagram showing a list of the paths that can be passed through by the control flow of the MLSL program shown in FIG. 9B.

FIG. 11 is a flow chart for explaining the conditional expression generating processing in detail.

FIG. 12A to 12C are diagrams for explaining an example where generating conditional expressions fails in the process of generating the test program from the MLSL program. FIGS. 12A and 12B are diagrams showing examples of the MLSL program. FIG. 12C is a diagram showing an example of the program after the conditional expression candidates are generated.

FIG. 13 is a diagram showing a list of the paths that can be passed through by the control flow of the MLSL program shown in FIG. 12B.

FIG. 14 is a flow chart for explaining the initial value generating processing in detail.

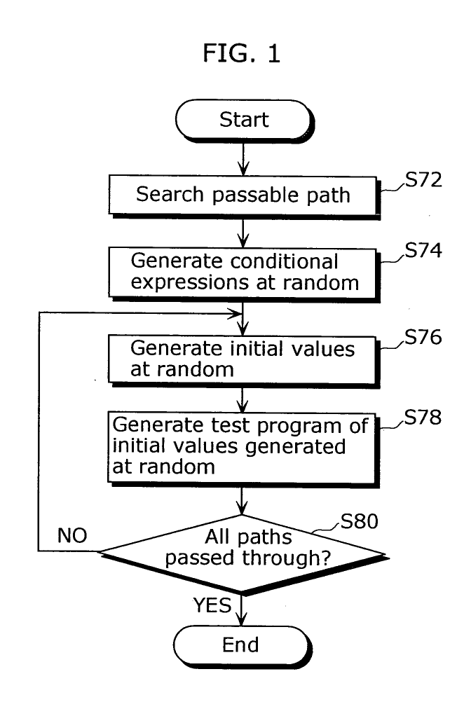

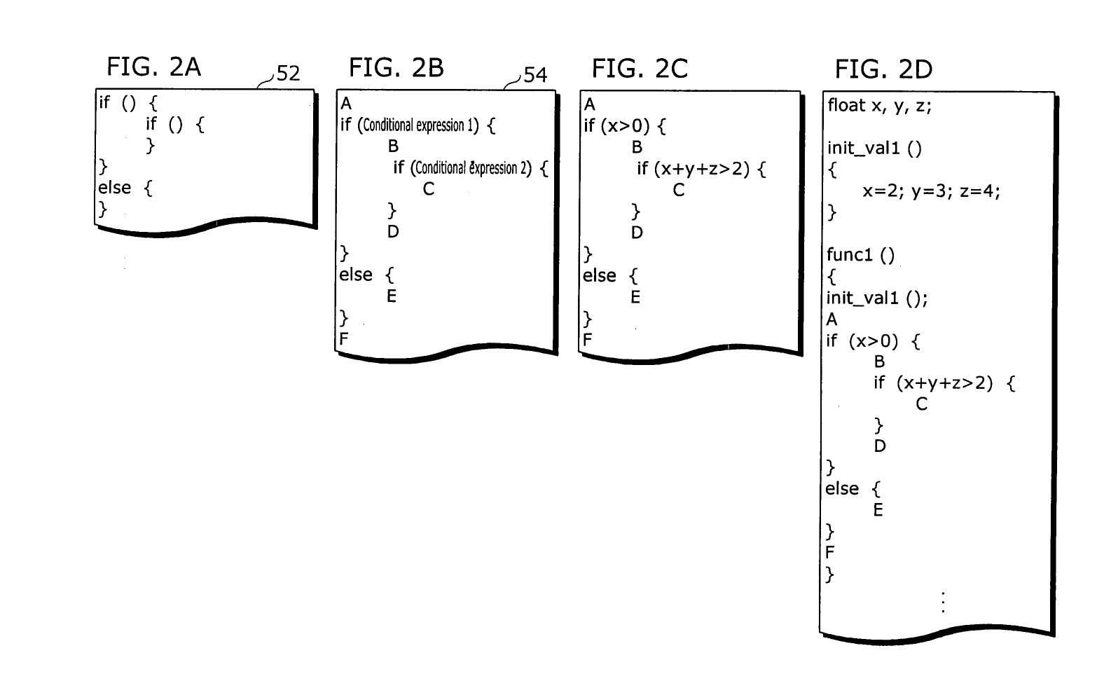

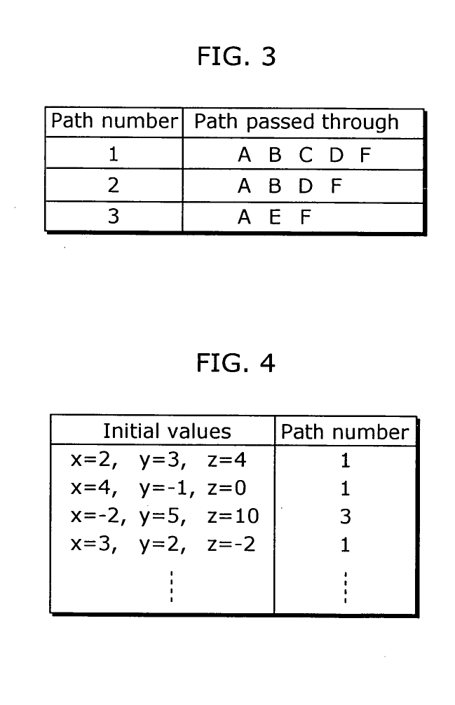

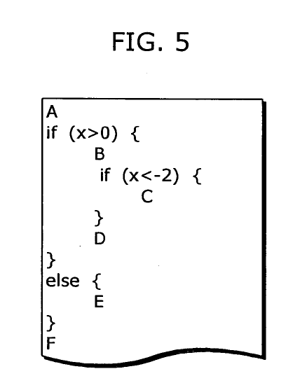

### DESCRIPTION OF THE PREFERRED EMBODIMENT(S)

The specific embodiment of the present invention will be explained below with reference to figures.

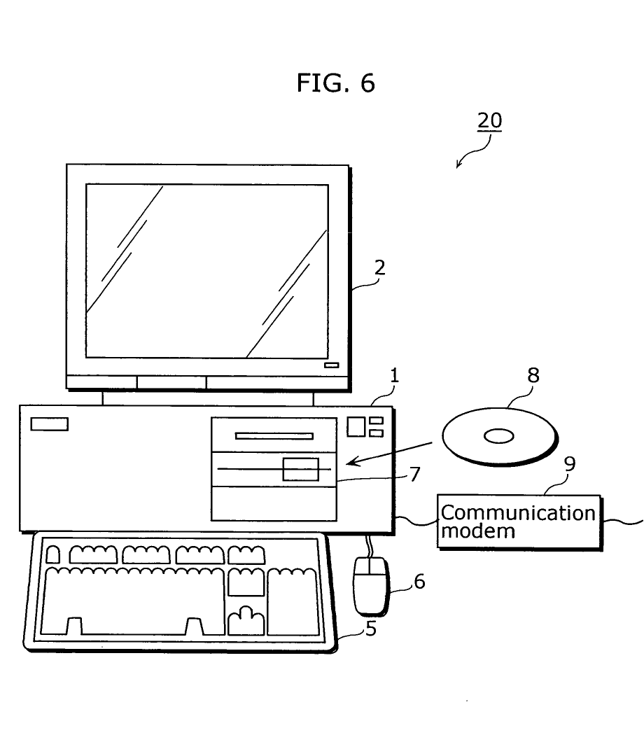

FIG. 6 is an external view of the program generating apparatus concerning the embodiment of the present invention. The program generating apparatus 20 is an apparatus for automatically generating a test program for a compiler, comprising a computer 1, a keyboard 5, a mouse 6, a monitor 2 for presenting information such as an operation result of the computer 1, a CD-ROM apparatus 7 and a communication modem 9.

The program executed by the program generating apparatus 20 is stored in the CD-ROM 8 and read by the CD-ROM apparatus 7. Or, it exists on the computer network and is read via the communication modem 9.

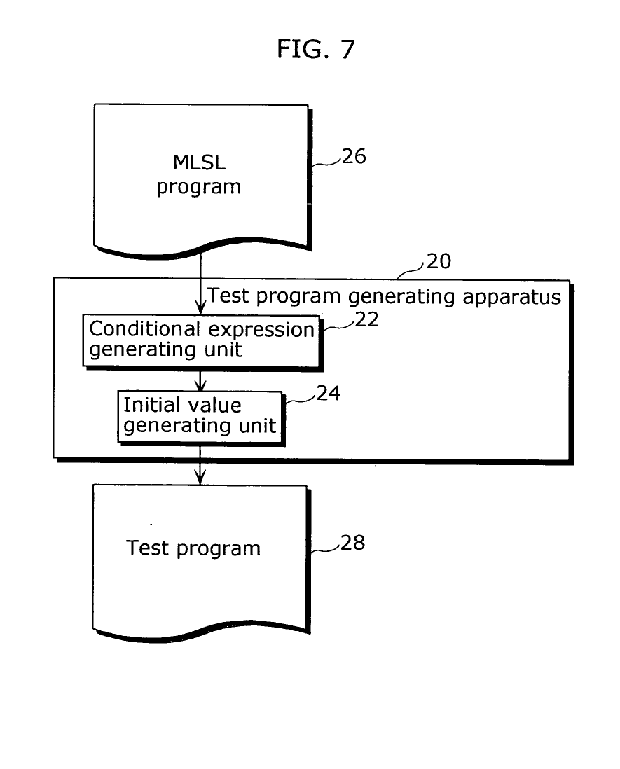

FIG. 7 is a block diagram showing the functional structure of the program generating apparatus concerning the embodiment of the present invention. The test program generating apparatus 20 comprises a conditional expression generating unit 22 and an initial value generating unit 24. It is assumed that a compiler is a compiler of C language in the following example, but a language is not limited to C language.

The conditional expression generating apparatus 22 reads the MLSL program 26 and generates conditional expressions to be inserted into the insertion parts of the conditional expressions of the MLSL program 26. The MLSL program 26 is a program described in the middle script language (MLSL) like the case in the background art, and describes the control structure of the test program to be generated.

The initial value generating unit 24 generates initial values of variables included in the conditional expressions generated in the conditional expression generating unit 22, and makes a test program 28. The test program 28 is described in C language, compiled in the compiler for C language and executed.

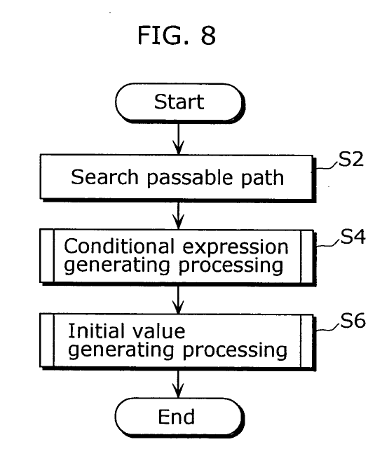

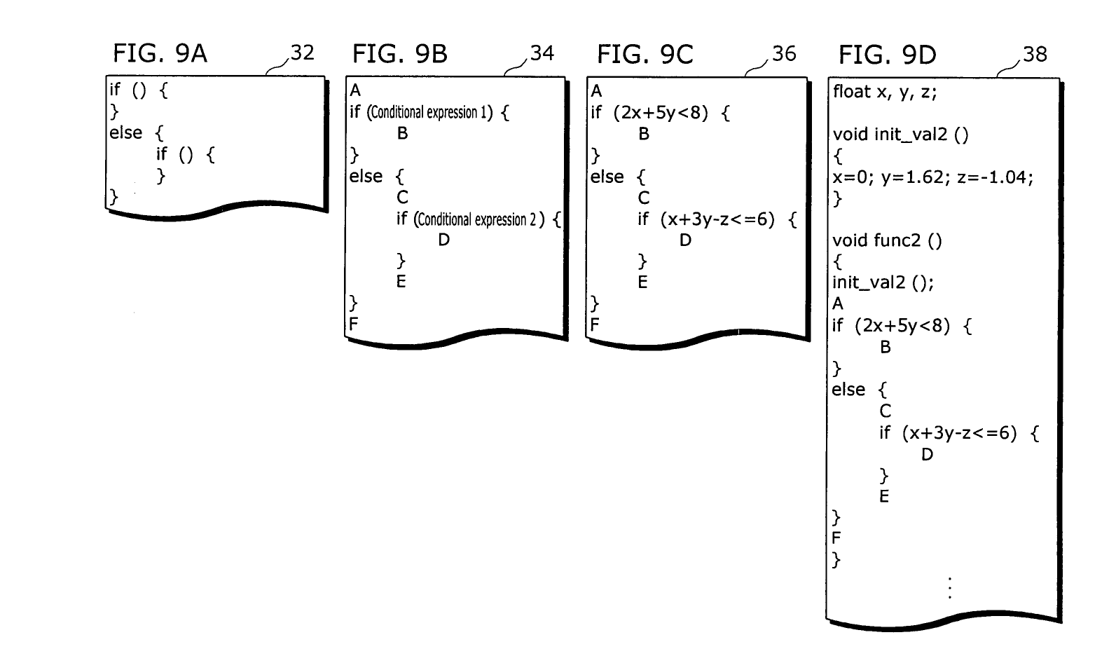

The operation of the test program generating apparatus 20 structured up to this point will be explained below. FIG. 8 is a flow chart of the processing executed by the test program generating apparatus 20. The conditional expression generating unit 22 reads the MLSL program 26 and searches passable paths in the control structure described in the MLSL program 26 (S2). For example, the conditional expression generating unit 22 reads the MLSL program 32 shown in FIG. 9A. Note that the conditional expression generating unit 22 interprets the MLSL program 32 as the MLSL program 34 shown in FIG. 9B. In other words, like the conventional test program generating apparatus, alphabets A to F show the locations that are passed through by the control flow of the program while it is being executed, and it is interpreted that assignment statements such as “a=a+1;” functions or the like are described in the passing locations A to F. Also, it is interpreted that conditional expressions of inequalities are described in the conditional expressions 1 and 2.

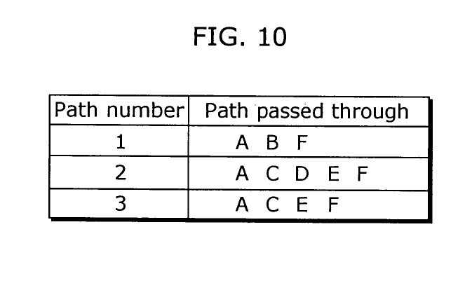

FIG. 10 is a diagram showing a list of paths that are passed by the control flow of the MLSL program 34. In other words, the control flow of the MLSL program 34 can pass through three paths. For example, in the case where both the conditional expressions 1 and 2 are true, as shown in the pass number 1, the control flow of the program passes through the passing locations A, B and F.

Next, the conditional expression generating unit 22 generates conditional expressions that allow the control flow of the MLSL program to surely pass through all the paths using a linear programming method and inserts conditional expressions generated in the insert parts of the conditional expressions of the MLSL program (S4). Like the program 36 shown in FIG. 9C, inequalities “2x+5y<8” and “x+3y−z<=6” that are to be inserted into the conditional expressions 1 and 2 are generated respectively, and detailed explanation as to the conditional expression generating processing will be made later.

Lastly, the initial value generating unit 24 performs processing for generating initial values of variables included in the generated conditional expressions using a linear programming method and generates a test program for compiler (S6). In the test program 38, initial value setting function init_val2( ) is generated as shown in FIG. 9D, and initial value generating processing will be explained in detail later. Also, function init_val2( ) is called in the leading part of the test function func2( ) of the compiler, initial values of variables x, y and z (x=0; y=1.62; z=−1.04) are set. In the test function func2( ), calling the initial value setting function init_val2( ) makes the conditional expression 1 (2x+5y=8.1<8) shown in the program 36 false and the conditional expression 2 (x+3y−z=5.9<=6) true shown in the program 36, and thus the control flow of the program 36 passes through the path of path number 2 shown in FIG. 10. Initial values for making the control flow of the program pass through other paths are generated in the initial value generating processing (S6). Note that values of the variables included in the conditional expressions become invariable after the initial values are assigned. This is the precondition for using a linear programming method at the time of obtaining conditional expressions and initial values.

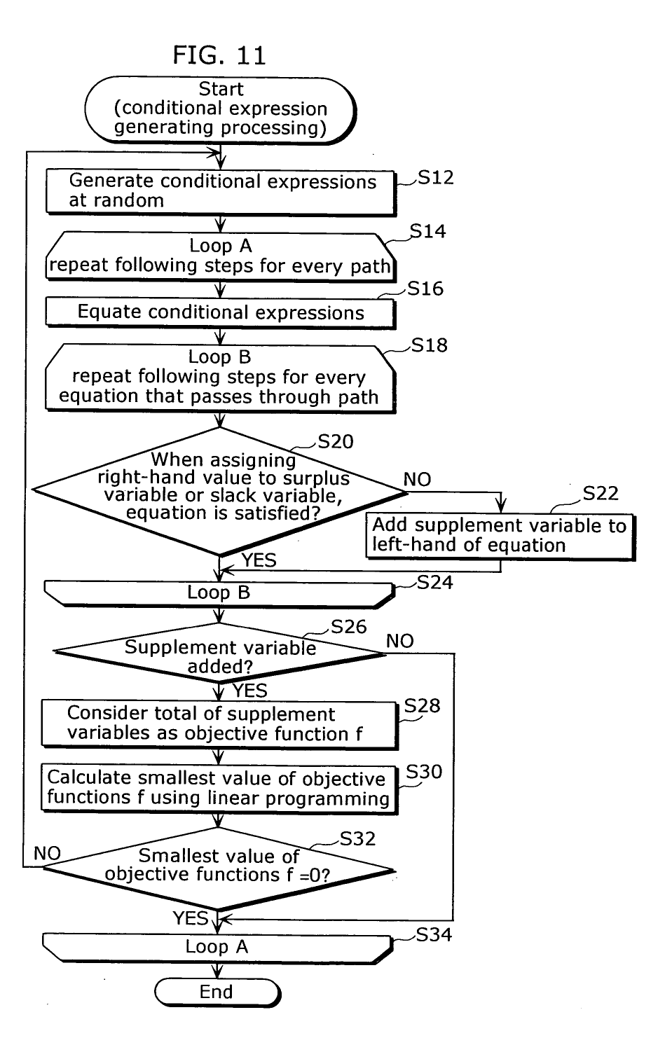

Next, conditional expression generating processing (S4 in FIG. 8) by the conditional expression generating unit 22 will be explained in detail indicating specific examples. FIG. 11 is a flow chart for explaining the conditional expression generating processing in detail.

The conditional expression generating unit 22 generates conditional expressions at random and inserts the generated conditional expressions into the insert parts of the conditional expressions of the MLSL program (S12). Note that the conditional expressions to be generated are assumed to be linear inequalities. In other words, no quadratic or higher degree expression is included in the conditional expressions. Also, no logical operators such as “&&” and “||” in C language are included. For example, the conditional expression generating unit 22 generates conditional expressions “2x+5y<8” and “x+3y−z<=6” and inserts them into the insert parts of the conditional expressions of the MLSL program 34 (conditional expressions 1 and 2) shown in FIG. 9B. This enables obtaining the program 36 shown in FIG. 9C.

The conditional expression generating unit 22 checks, using a linear programming method, whether or not the control flow of the program passes through each of the paths that may be passed by the control flow of the MLSL program while the program is being executed. In other words, the conditional expression generating unit 22 formulates conditions that are satisfied by the conditional expressions so as to make the control flow of the program pass through current paths and equates the formulated conditional expressions (S16).

For example, in order to make the control flow of the program pass through the path of path number 2 shown in FIG. 10 in the conditional expressions shown in the program 36, it is requisite that conditional expression “2x+5y<8” is false and the conditional expression “x+3y−z<=6” is true as expressed by the following expressions 1 and 2 respectively.
2x+5y<8==FALSE 1
x+3y−z<=6==TRUE 2

In this way, expressions 1 and 2 are formulated like the following expressions 3 and 4.
2x+5y>=8 3
x+3y−z<=6 4

In order to equate the formulated conditional expressions, constants in the left hand of the inequalities are transposed to the right hand first and variables in the right hand of the inequalities are transposed to the left hand. Multiplying both sides by “−1” in the case where the value of the right hand is negative makes the constant value of the right hand non-negative. The conditional expressions 3 and 4 are kept intact because no constants a re included in the left hands, no variables are included in the right hands, and the constant values of the right hands are non-negative.

Next, a surplus variable v₁ is introduced in the expression 3 and a slack variable v₂ is introduced in the expression 4 based on the linear programming method. Also, variables x included in the expressions 3 and 4 are transformed into (x₁−x₂)(where x₁, x₂>0). Variables y and z are transformed in a similar manner. In this way, expressions 3 and 4 are equated respectively like the following expressions 5 and 6.
2x₁−2x₂+5y₁−5y₂−v₁=8 5
x₁−x₂+3y₁−3y₂−z₁+z₂+v₂=6 6
where x₁, x₂, y₁, y₂, z₁, z₂, v₁, v₂>=0

Next, the conditional expression generating unit 22 assigns values of the right hands to the surplus variable and the slack variable in the respective one of equalities generated by the equality processing (S16) and checks (S20) whether the equalities are satisfied or not by making the values of the other variables 0. In the case where the equalities are not satisfied (NO in S20), supplement variables are added to the left hand of the equalities (S22). The above-mentioned processing is performed on all the equalities (S18 to S24).

For example, even in the case where the right hand value 8 is assigned to the variable v₁ in the expression 5 and 0 is assigned to the other variables in the expression 5, the equalities cannot be satisfied. Therefore, a supplement variable m₁ is added to the left hand of the expression 5 and the following expression 7 is made. On the other hand, the right hand value 6 is assigned to the variable v₂ in the expression 6 and 0 is assigned to the other variables, which makes it possible to satisfy the equalities. Therefore, no supplement variable is added to the expression 6.
2x₁−2x₂+5y₁−5y₂−v₁+m₁=8 7
where x₁, x₂, y₁, y₂, v₁, m₁>=0

Next, the conditional expression generating unit 22 checks whether supplement variables are added to any of equalities or not (S26). In the case where supplement variables are added (YES in S26), the total of supplement variables is objective function f (S28). In other words, the objective function f is shown in the following expression 8 in the above-mentioned example.
f=m₁ 8

The conditional expression generating unit 22 calculates the smallest value of the objective functions f according to the linear programming method under the condition of the equality obtained by the equating processing (S16) or the supplement variable adding processing (S22). In other words, in the above-mentioned example, the smallest value of the objective functions f shown in FIG. 8 is calculated under the constraints shown in the expressions 7 and 6. As a result, the smallest value of the objective functions f is 0 when the following expressions 9 to 11 are satisfied.
x=x₁−x₂=0 9
y=y₁−y₂=1.62 10
z=z₁−z₂=−1.04 11

In other words, setting the initial values of the variables x, y and z as shown in the expressions 9 to 11 makes it possible to make the control flow of the program pass through the path of path number 2 shown in FIG. 10.

In the case where the smallest value of the objective functions f is 0 (YES in S32) or no supplement variable is added to any equalities (NO in S26), it is proved that current paths are passable. Therefore, the processing (S16 to S32) for checking whether or not the other paths are passable in the case of using the same conditional expression is repeated (S14 to S34).

In the case where the smallest value of the objective functions f is not 0 (NO in S32), the conditional expression that is now set cannot make the control flow of the program pass through current paths.

Therefore, conditional expressions are generated at random again (S12), the above-mentioned processing is repeated until conditional expressions that allow the control flow of the program to pass through all the paths by changing initial values of variables included in the conditional expressions (S14 to S34).

After executing the conditional expression generating processing explained up to this point, selecting initial values appropriately generates a program including the conditional expressions that allow the control flow of the program to pass through all the paths.

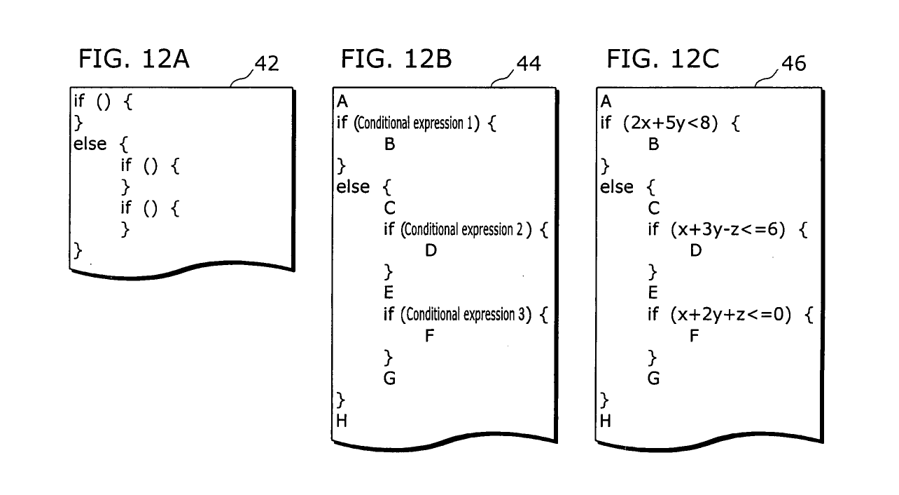

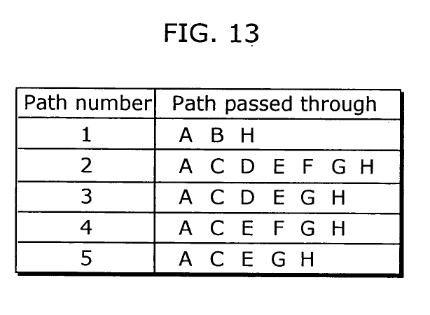

Next, an example where the smallest value of the objective functions f is not 0 will be explained with reference to FIGS. 12A to 13. The conditional expression generating unit 22 reads the MLSL program 42 shown in FIG. 12A. The conditional expression generating unit 22 interprets the MLSL program 42 as the MLSL program 44 shown in FIG. 12B. Conditional expressions generated in the conditional expression randomly generating processing (S12 in FIG. 11) are inserted into the insert parts of the conditional expressions of the MLSL program 44 (conditional expressions 1, 2 and 3) in the program 46 shown in FIG. 12C. For example, an inequality “2x+5y<8” is inserted into the insert parts of the conditional expression 1.

FIG. 13 is a diagram showing a list of paths that can be passed by the control flow of the MLSL program 44. In other words, the control flow of the MLSL program 44 may pass through five paths. For example, in the case where the conditional expression 1 “2x+5y<8” is false, the conditional expression 2 “x+3y−z<=6” is true and the conditional expression 3 “x+2y+z<=0” is true in the program 46, path of the path number 2 are passed through.

In order to pass through the path of the path number 2, it is requirement that the following expressions 12 to 14 are satisfied.
2x+5y<8==FALSE 12
x+3y−z<=6==TRUE 13
x+2y+z<=0==TRUE 14

Therefore, the expressions 12 to 14 are formulated respectively in the formulation processing (S16) first to make the following expressions 15 to 17.
2x+5y>=8 15
x+3y−z<=6 16
x+2y+z<=0 17

Each variable of the formulated conditional expressions are transformed, a surplus variable v₁ is introduced in the expression 15, a slack variable v₂ and V₃ are introduced in the expressions 16 and 17 respectively, which equates the expressions 15 to 17 respectively to make the following expressions 18 to 20.
2x₁−2x₂+5y₁−5y₂−v₁=8 18
x₁−x₂+3y₁−3y₂−z₁+z₂+v₂=6 19
x₁−x₂+2y₁−2y₂+z₁−z₂+v₃=0 20
where x₁, x₂, y₁, y₂, z₁, z₂, v₁, v₂, v₃>=0

Supplement variable m₁ is added to the expression 18 and the following expression 21 is made in the supplement variable adding processing (S18 to S24).
2x1−2x₂+5y₁−5y₂−v₁+m₁=8 21
where x₁, x₂, y₁, y₂, v₁, m₁>=0

Therefore the objective function f is shown like the following expression 22.
f=m₁ 22

The initial value generating unit 24 calculates the smallest value of the objective functions f under the constraints shown in the expressions 21, 18 and 19 (S30), the smallest value of the objective functions f becomes bigger than 0. Therefore, no values of variables x, y and z that satisfy the expressions 12 to 14 at the same time exist, and thus the path of path number 2 cannot be passed through.

As a result, conditional expressions are generated at random again.

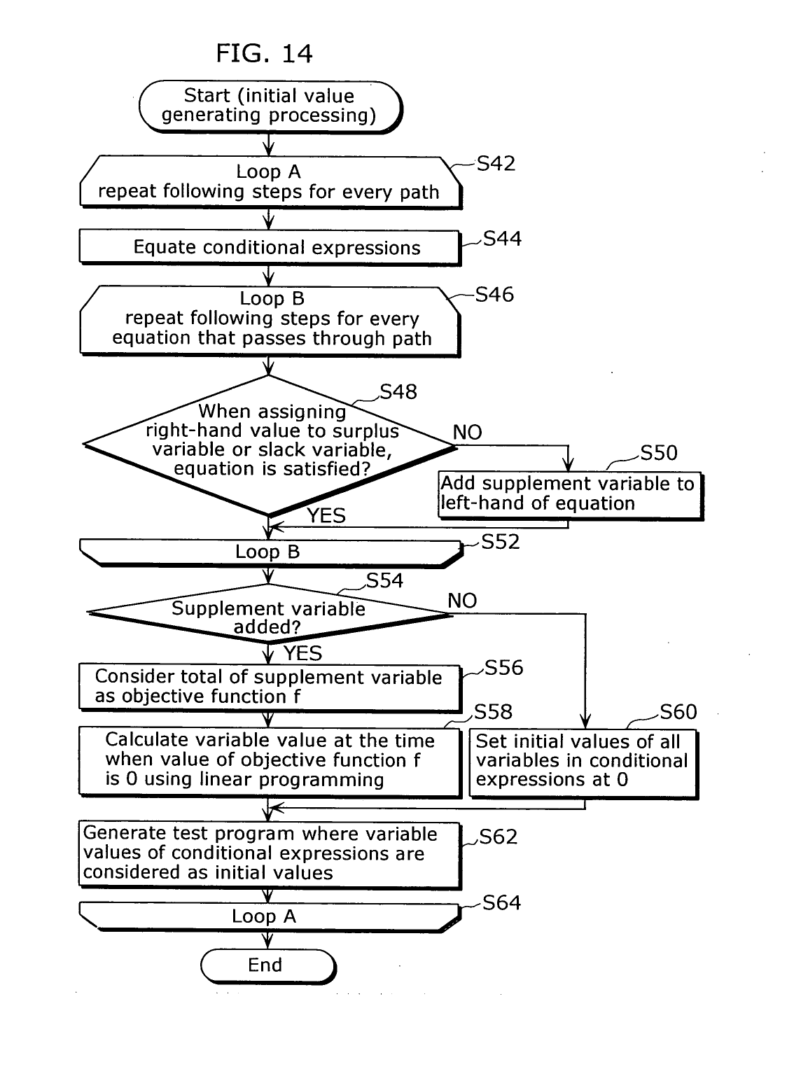

Next, the initial value generating processing (S6 in FIG. 8) by the initial value generating unit 24 will be explained in detail with reference to specific examples. FIG. 14 is a flow chart for explaining the initial value generating processing in detail.

The initial value generating unit 24 calculates the initial values of variables included in the conditional expressions concerning each path that can be passed through by the control flow of the MLSL program using a linear programming method so as to generate a test program. In other words, the initial value generating unit 24 formulates the conditions that are satisfied by the conditional expressions so as to make the control flow of the test program pass through current paths and equates the formulated conditional expressions (S44). As this processing is the same as the equating processing by the conditional expression generating unit 22 shown in FIG. 11 (S16), no detailed explanation on it will be repeated.

Next, the initial value generating unit 24 executes the processing for adding a supplement variable to the equated conditional expression (S46 to S52). As this processing is also the same as the supplement variable adding processing (S18 to S24) by the conditional expression generating unit 22 shown in FIG. 11, no detailed explanation on it will be repeated.

The initial value generating unit 24 judges whether the supplement variable is added to any of the equated conditional expressions or not (S54). In the case where supplement variables are added (YES in S54), the total of the supplement variables is considered as the objective function (S56), and calculates the value of variables at the time where the smallest value of the objective functions f becomes 0 using a linear programming method (S58) under the condition of equalities calculated in the equating processing (S44) or the supplement variable adding processing (S50).

For example, when calculating the value of the variable included in the conditional expression at the time when the objective function f becomes 0 shown in the expression 8 under the constraint shown in the expressions 7 and 6, expressions 9 to 11 can be obtained.

When no supplement variable is added (NO in S54), initial values of the variables included in the conditional expressions are set at 0 (S60).

After calculating initial values of the variables included in the conditional expressions (S58, S60), the initial value generating unit 24 generates the test program for setting the initial values in the conditional expressions (S62). For example, as a test program whose control flow passes through the path of path number 2 shown in FIG. 10, the test program 38 shown in FIG. 9D is made. In the test program 38, as explained above, the initial value setting function init_val2( ) is called in the leading part of the test function func2( ), which sets initial values for the variables included in the conditional expressions. Executing the test function func2( ) based on this initial values makes it possible to carry out a test for checking whether the path of path number 2 are passed through or not.

The same processing is performed on the other paths, and a test program is generated (S42 to S64). Note that the initial value setting function and the test function in the other paths may be stored in the same file as the one used for the test program 38 and may be stored in a different file.

The above-mentioned processing makes it possible to generate a test program whose control flow can pass through all the paths that can be passed by the control flow of the MLSL program.

Up to this point, the test program generating apparatus concerning the present invention has already been explained in this embodiment, but the present invention is not limited to this embodiment.

For example, the supplement variable may be introduced for all equalities.

Also, in the above-mentioned embodiment, it is assumed that the conditional expression is a linear inequality, but the conditional expression is not limited to the linear inequality, in other words, any kind of expression may be used as long as a linear programming method is applicable like the case of the linear equation.

As explained up to this point, this present invention makes it possible to generate a test program whose control flow passes through all the paths in a short time.

Also, it is possible to generate a test program whose control flow surely passes through all the paths.

Although only the exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

As explained up to point, the present invention is suitable for rapidly and accurately generating a test program for checking whether the compiler operates right at the time of generating the compiler for high level language.

1. A program generating apparatus comprising:
a conditional expression generating unit operable to receive a description of a control structure of a program and generate a plurality of conditional expressions to be inserted into insert parts of the conditional expressions of the control structure using a linear programming method, the plurality of conditional expressions allowing a control flow of the program to pass through all paths in the control structure;
an initial value generating unit operable to generate initial values of variables, for each of all the paths, which are included in the plurality of conditional expressions for allowing the control flow of the program to pass through all the paths in the control structure; and
a program generating unit operable to generate a test program based on the control structure, the plurality of conditional expressions and the initial values.

2. The program generating apparatus according to claim 1,
wherein values of variables included in the plurality of conditional expressions are invariable after the initial values are assigned.

3. The program generating apparatus according to claim 1,
wherein each of the plurality of conditional expressions is a linear inequality.

4. The program generating apparatus according to claim 1,
wherein the conditional expression generating apparatus includes:
a conditional expression candidate generating subunit operable to generate, at random, candidates for the plurality of conditional expressions to be inserted into the insert parts of the conditional expressions of the control structure;
an equating subunit operable to formulate conditions to be satisfied by the plurality of conditional expressions for allowing the control flow of the program to pass through each of all the paths in the control structure and equate the plurality of conditional expressions by introducing a surplus variable or a slack variable to each of the plurality of formulated conditional expressions;
a supplement variable introducing subunit operable to introduce a supplement variable to each of the plurality of the equated conditional expressions;
an optimum value calculating subunit operable to calculate an optimum value of an objective function according to a linear programming method, considering a total of the supplement variables as the objective function and the plurality of conditional expressions where supplement variables are introduced by the supplement variable introducing subunit as constraints; and
a path passage judging subunit operable to judge whether current path can be passed or not based on the optimum value of the objective function.

5. The program generating apparatus according to claim 1,
wherein the conditional expression generating unit includes:
a conditional expression candidate generating subunit operable to generate, at random, candidates for the plurality of conditional expressions to be inserted into the insert parts of the conditional expressions of the control structure;
an equating subunit operable to formulate conditions to be satisfied by the plurality of conditional expressions for allowing the control flow of the program to pass through each of all the paths in the control structure, and equate the plurality of conditional expressions by introducing a surplus variable or a slack variable to each of the plurality of formulated conditional expressions;
a supplement variable introducing subunit operable to introduce a supplement variable to each of the plurality of the equated conditional expressions in the case where assigning a constant included in current conditional expression to the surplus variable or the slack variable and assigning 0 to the other variables do not satisfy said each equated conditional expression;
an optimum value calculating subunit operable to calculate, in the case where a supplement variable is introduced to any of the plurality of conditional expressions, an optimum value of an objective function according to a linear programming method, considering a total of the supplement variables as the objective function and considering the plurality of equated conditional expressions where the surplus variable, the slack variable or the supplement variable is included as constraints; and
a path passage judging subunit operable to judge whether current path can be passed or not based on the optimum value of the objective function in the case where the supplement variable is introduced into any of the plurality of conditional expressions.

6. The program generating apparatus according to claim 1,
wherein the initial value generating unit generates initial values of variables, for each of all the paths, which are included in the plurality of conditional expressions for allowing the control flow of the program to pass through all the paths in the control structure using the linear programming method.

7. The program generating apparatus according to claim 6,
wherein the values of variables included in the plurality of conditional expressions are invariable after the initial values are assigned.

8. The program generating apparatus according to claim 6,
wherein each of the plurality of the conditional expressions are a linear inequality.

9. The program generating apparatus according to claim 6,
wherein the conditional expression generating apparatus includes:
a conditional expression candidate generating subunit operable to generate, at random, candidates for the plurality of conditional expressions to be inserted into the insert parts of the conditional expressions of the control structure;
an equating subunit operable to formulate conditions to be satisfied by the plurality of conditional expressions for allowing the control flow of the program to pass through each of all the paths in the control structure and equate the plurality of conditional expressions by introducing a surplus variable or a slack variable to each of the plurality of formulated conditional expressions;
a supplement variable introducing subunit operable to introduce a supplement variable to each of the plurality of the equated conditional expressions;
an optimum value calculating subunit operable to calculate an optimum value of the objective function according to a linear programming method, considering a total of the supplement variables as the objective function and considering the plurality of conditional expressions where supplement variables are introduced by the supplement variable introducing subunit as constraints; and
a path passage judging subunit operable to judge whether current path can be passed or not based on the optimum value of the objective function.

10. The program generating apparatus according to claim 9,
wherein the initial value generating unit includes:
an equating subunit operable to formulate conditions to be satisfied by the plurality of conditional expressions, which are obtained in the conditional expression generating unit, for allowing the control flow of the program to pass through each of all the paths in the control structure and equate the plurality of conditional expressions by introducing a surplus variable or a slack variable to each of the formulated plurality of conditional expressions;
a supplement variable introducing subunit operable to introduce a supplement variable to each of the plurality of the equated conditional expressions; and
an initial value calculating subunit operable to make the values of variables when the objective function takes the optimum value, which are included in the plurality of conditional expressions, as the initial values of variables according to the linear programming method, considering a total of the supplement variables as the objective function and considering the plurality of conditional expressions where supplement variables are introduced by the supplement variable introducing subunit as constraints.

11. The program generating apparatus according to claim 6,
wherein the conditional expression generating apparatus includes:
a conditional expression candidate generating subunit operable to generate, at random, candidates for the plurality of conditional expressions to be inserted into the insert parts of the conditional expressions of the control structure;
an equating subunit operable to formulate conditions to be satisfied by the plurality of conditional expressions for allowing the control flow of the program to pass through each of all the paths in the control structure;
a supplement variable introducing subunit operable to introduce a supplement variable to each of the plurality of the equated conditional expressions in the case where assigning a constant included in current conditional expression to the surplus variable or the slack variable and assigning 0 to the other variables do not satisfy said each equated conditional expression;
an optimum value calculating subunit operable to calculate, in the case where a supplement variable is introduced to any of the plurality of conditional expressions, an optimum value of an objective function according to a linear programming method, considering a total of the supplement variables as the objective function and considering the plurality of equated conditional expressions where the surplus variable, the slack variable or the supplement variable is included as constraints; and
a path passage judging subunit operable to judge whether current path can be passed or not based on the optimum value of the objective function in the case where the supplement variable is introduced into any of the plurality of conditional expressions.

12. The program generating apparatus according to claim 11,
wherein the initial value generating unit includes:
an equating subunit operable to formulate conditions to be satisfied by the plurality of conditional expressions, which are obtained in the conditional expression generating unit, for allowing the control flow of the program to pass through each of all the paths in the control structure and equate the plurality of conditional expressions by introducing the surplus variable or a slack variable to each of the formulated plurality of conditional expressions;
a supplement variable introducing subunit operable to introduce a supplement variable to each of the plurality of the equated conditional expressions in the case where assigning a constant included in current conditional expression to the surplus variable or the slack variable and assigning 0 to the other variables do not satisfy said each equated conditional expression; and
an initial value calculating subunit operable to make the values of variables when the objective function takes the optimum value, which are included in the plurality of conditional expressions, as the initial values of variables according to the linear programming method, considering a total of the supplement variables as an objective function in the case where a supplement variable is introduced into any of the plurality of the conditional expressions and considering the plurality of the equated conditional expressions where a surplus variable, a slack variable or a supplement variable is included as constraints.

13. The program generating apparatus according to claim 6,
wherein the initial value generating unit includes:
an equating subunit operable to formulate conditions to be satisfied by the plurality of conditional expressions, which are obtained in the conditional expression generating unit, for allowing the control flow of the program to pass through each of all the paths in the control structure and equate the plurality of conditional expressions by introducing a surplus variable or a slack variable to each of the formulated plurality of conditional expressions;
a supplement variable introducing subunit operable to introduce a supplement variable to each of the plurality of the equated conditional expressions; and
an initial value calculating subunit operable to make the values of variables when the objective function takes the optimum value, which are included in the plurality of conditional expressions, as the initial values of variables according to the linear programming method, considering a total of the supplement variables as the objective function and the plurality of conditional expressions where supplement variables are introduced by the supplement variable introducing subunit as constraints.

14. The program generating apparatus according to claim 6,
wherein the initial value generating unit includes:
an equating subunit operable to formulate conditions to be satisfied by the plurality of conditional expressions, which are obtained in the conditional expression generating unit, for allowing the control flow of the program to pass through each of all the paths in the control structure and equate the plurality of conditional expressions by introducing a surplus variable or a slack variable to each of the formulated plurality of conditional expressions;
a supplement variable introducing subunit operable to introduce a supplement variable to each of the plurality of the equated conditional expressions in the case where assigning a constant included in current conditional expression to the surplus variable or the slack variable and assigning 0 to the other variables do not satisfy said each equated conditional expression; and
an initial value calculating subunit operable to make the values of variables when the objective function takes the optimum value, which are included in the plurality of conditional expressions, as the initial values of variables according to the linear programming method, considering a total of the supplement variables as the objective function in the case where a supplement variable is introduced into any of the plurality of the conditional expressions and considering the plurality of the equated conditional expressions where a surplus variable, a slack variable or a supplement variable is included as constraints.

15. A program generating apparatus comprising:
a conditional expression generating unit operable to receive a description of a control structure of a program and generate a plurality of conditional expressions to be inserted into insert parts of the conditional expressions of the control structure, the plurality of conditional expressions allowing a control flow of the program to pass through all paths in the control structure;
an initial value generating unit operable to generate initial values of variables, for each of all the paths using a linear programming method, which are included in the plurality of conditional expressions for allowing the control flow of the program to pass through all the paths in the control structure; and
a program generating unit operable to generate a test program based on the control structure, the plurality of conditional expressions and the initial values.

16. The program generating apparatus according to claim 15,
wherein values of variables included in the plurality of conditional expressions are invariable after the initial values are assigned.

17. The program generating apparatus according to claim 15,
wherein each of the plurality of conditional expressions is a linear inequality.

18. The program generating apparatus according to claim 15,
wherein the initial value generating unit includes:
an equating subunit operable to formulate conditions to be satisfied by the plurality of conditional expressions, which are obtained in the conditional expression generating unit, for allowing the control flow of the program to pass through each of all the paths in the control structure and equate the plurality of conditional expressions by introducing a surplus variable or a slack variable to each of the formulated plurality of conditional expressions;
a supplement variable introducing subunit operable to introduce a supplement variable to each of the plurality of the equated conditional expressions; and
an initial value calculating subunit operable to make the values of variables when the objective function takes the optimum value, which are included in the plurality of conditional expressions, as the initial values of variables according to the linear programming method, considering a total of the supplement variables as the objective function and considering the plurality of conditional expressions where supplement variables are introduced by the supplement variable introducing subunit as constraints.

19. The program generating apparatus according to claim 15,
wherein the initial value generating unit includes:
an equating subunit operable to formulate conditions to be satisfied by the plurality of conditional expressions, which are obtained in the conditional expression generating unit, for allowing the control flow of the program to pass through each of all the paths in the control structure and equate the plurality of conditional expressions by introducing a surplus variable or a slack variable to each of the formulated plurality of conditional expressions;
a supplement variable introducing subunit operable to introduce a supplement variable to each of the plurality of the equated conditional expressions in the case where assigning a constant included in current conditional expression to the surplus variable or the slack variable and assigning 0 to the other variables do not satisfy said each equated conditional expression; and
an initial value calculating subunit operable to make the values of variables when the objective function takes the optimum value, which are included in the plurality of conditional expressions, as the initial values of variables according to the linear programming method, considering a total of the supplement variables as the objective function in the case where a supplement variable is introduced into any of the plurality of the conditional expressions and considering the plurality of the equated conditional expressions where a surplus variable, a slack variable or a supplement variable is included as constraints.

20. A program generating method comprising:
a conditional expression generating step of receiving a description of a control structure of a program and generating a plurality of conditional expressions to be inserted into insert parts of the conditional expressions of the control structure using a linear programming method, the plurality of conditional expressions allowing a control flow of the program to pass through all paths in the control structure;
an initial value generating step of generating initial values of variables, for each of all the paths, which are included in the plurality of conditional expressions for allowing the control flow of the program to pass through all the paths in the control structure; and
a program generating step of generating a test program based on the control structure, the plurality of conditional expressions and the initial values.

21. The program generating method according to claim 20,
in the initial value generating step, initial values of variables included in the plurality of conditional expressions for allowing the control flow of the program to pass through each of all the paths in the control structure using the linear programming method.

22. A program generating method comprising:
a conditional expression generating step of receiving a description of a control structure of a program and generating a plurality of conditional expressions to be inserted into insert parts of the conditional expressions of the control structure, the plurality of conditional expressions allowing a control flow of the program to pass through all paths in the control structure;
an initial value generating step of generating initial values of variables, for each of all the paths using a linear programming method, which are included in the plurality of conditional expressions for allowing the control flow of the program to pass through all the paths in the control structure; and
a program generating step of generating a test program based on the control structure, the plurality of conditional expressions and the initial values.

23. A program for causing a computer to execute following steps:
a conditional expression generating step of receiving a description of a control structure of a program and generating a plurality of conditional expressions to be inserted into insert parts of the conditional expressions of the control structure using a linear programming method, the plurality of conditional expressions allowing a control flow of the program to pass through all paths in the control structure;
an initial value generating step of generating initial values of variables, for each of all the paths, which are included in the plurality of conditional expressions for allowing the control flow of the program to pass through all the paths in the control structure; and
a program generating step of generating a test program based on the control structure, the plurality of conditional expressions and the initial values.

24. The program according to claim 23,
in the initial value generating step, initial values of variables included in the plurality of conditional expressions for allowing the control flow of the program to pass through each of all the paths in the control structure using the linear programming method.

25. A program for causing a computer to execute the following steps:
a conditional expression generating step of receiving a description of a control structure of a program and generating a plurality of conditional expressions to be inserted into insert parts of the conditional expressions of the control structure, the plurality of conditional expressions allowing a control flow of the program to pass through all paths in the control structure;
an initial value generating step of generating initial values of variables, for each of all the paths using a linear programming method, which are included in the plurality of conditional expressions for allowing the control flow of the program to pass through all the paths in the control structure; and
a program generating step of generating a test program based on the control structure, the plurality of conditional expressions and the initial values.
